(19) United States
(12) Patent Application Publication
(10) Pub. No.: US 2024/0407589 A1
(43) Pub. Date: Dec. 12, 2024

(54) MACHINE AND METHOD FOR PREPARING BEVERAGES

(71) Applicant: DE' LONGHI APPLIANCES S.R.L. CON UNICO SOCIO, Treviso (IT)

(72) Inventors: Simone Rosetta, Treviso (IT); Guido Quaratesi, Treviso (IT); Thomas Zanardo, Treviso (IT)

(73) Assignee: DE' LONGHI APPLIANCES S.R.L. CON UNICO SOCIO, Treviso (IT)

(21) Appl. No.: 18/703,187

(22) PCT Filed: Oct. 18, 2022
(86) PCT No.: PCT/IT2022/050279

§ 371 Date: Apr. 19, 2024

(30) Foreign Application Priority Data
Oct. 19, 2021 (IT) 102021000026807

(51) Int. Cl. A47J 31/52; A47J 31/44

(52) U.S. Cl. CPC A47J 31/525; A47J 31/4403; A47J 31/4485; A47J 31/4489; A47J 31/521

(57) ABSTRACT

Machine (10) for preparing beverages, comprising a brewing unit (15) configured to prepare at least one certain beverage at a time, a main hydraulic circuit (16) to feed water to the brewing unit (15), a delivery unit (17) configured to deliver the certain beverage, a processor (33) operatively connected to the brewing unit (15), to the main hydraulic circuit (16) and to the delivery unit (17) in order to control and command their drive, a memory unit (36) connected to the processor (33) and a user interface (31) communicating with the processor (33) to select the certain beverage. The machine (10) also comprises recognition means (39) to detect the possible presence of activation means (40) which are at least temporarily associated with or integrated into the machine (10)

### FIELD OF THE INVENTION

The present invention concerns a machine and a method for preparing beverages, including coffee-based beverages. The machine can be either automatic, in which all the steps of preparing and delivering the beverage take place automatically, after a simple start command from the user, or semi-automatic, in which the user must perform at least the step of removing the aromatic blend used. Furthermore, the machine is mainly, although not exclusively, designed for domestic or semi-professional use, that is, for example, for offices or small communities.

### BACKGROUND OF THE INVENTION

Machines for preparing beverages, in particular coffee-based beverages, for domestic or semi-professional use, in which the beverage is obtained for example by brewing a coffee powder, are known. The brewing requires a plurality of different parameters to be set and controlled, such as the temperature, pressure and/or quantity of water, correlated to one or more functional units or components of the machine itself and which affect the brewing method. In most cases, the coffee powder is obtained by grinding the coffee beans, carried out by means of a grinding device present in the machine itself.

In addition, known machines are able to modify the preparation and/or the characteristics of the beverage on the basis of specific input given by the user or consumer, such as for example the type of beverage to be consumed (cappuccino, espresso, American coffee, etc.), or the degree of grinding of the beans, the brewing temperature, or possibly the intensity of the beverage to be obtained.

Document US-A-2006/011068 concerns a machine for preparing beverages which is provided with sensors suitable to detect the presence of a carafe in the delivery zone, in order to prevent unwanted spillages of the beverages.

US-2016/287004 describes a machine for preparing coffee beverages, comprising a control unit that regulates the brewing process according to a plurality of inputs received and on the basis of a computer program memorized in a memory unit. In particular, on the basis of the inputs and the program, specific sets of brewing parameters to be used can be defined. US-2016/287004 also provides to be able to obtain sets of operating parameters to be used for preparing a beverage by an external control unit.

Furthermore, known machines can also provide to prepare other beverages, cold or hot, such as tea and various infusions. In this case, brewing temperatures and times different from those required for preparing coffee-based beverages are generally required.

Therefore, these machines are designed to be provided with a plurality of preset commands and/or functions that the user can select from a specific user interface on the basis of specific consumption needs.

However, the presence of a large number of functions and/or commands, constantly active and visible on the user interface, has the disadvantage that the use of the machine is often complex and complicated, especially for non-expert users. In fact, usually, an average user does not have the necessary experience to easily select the many parameters and/or the many specific functions available to obtain the desired beverage, and therefore he/she is often forced to try, even several times, to modify his/her selection until the desired result is obtained.

On the other hand, there is an increasing need to provide machines for preparing beverages that are versatile and suitable to prepare beverages of different types, and in particular machines that can also be modified or integrated with new accessories or functions even after they have been purchased. However, the integration of new accessories or functions generally requires a software update which is often complex to perform, especially by inexperienced users.

There is therefore a need to perfect a machine for preparing beverages which can overcome at least one of the disadvantages of the state of the art.

In particular, one purpose of the present invention is to provide a machine and perfect a method for preparing beverages which provide the possibility for the user to update the functions, for example by adding functions or modifying them, of the basic machine after it has been put on the market.

Another purpose of the present invention is to provide a machine and perfect a method for preparing beverages, in which the addition or modification of additional functions takes place in a simple and substantially automatic manner, without the need for complex operations by the user.

Another purpose of the present invention is to provide a machine for preparing beverages which is simple to use and highly versatile.

All this by solving the technical problem of designing and manufacturing a machine for preparing beverages which is already provided with special devices, mechanisms and/or components, so that it can then be updated easily and with simple operations by the user, by means of suitable optional accessories.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, and to resolve the technical problem disclosed above in a new and original way, also achieving considerable advantages compared to the state of the prior art, a machine for preparing beverages according to the present invention comprises a brewing unit configured to prepare at least one certain beverage at a time, selected from the beverages disclosed above, a main hydraulic circuit to feed water to the brewing unit, a delivery unit fluidically connected to the brewing unit and configured to deliver the certain beverage, a processor operatively connected to the brewing unit, to the main hydraulic circuit and to the delivery unit in order to control and command their drive, electronic memory means connected to the processor and configured to store packets of data and programs relating to operating functions associated with the beverages disclosed above, and a user interface communicating with the processor in order to select the certain beverage.

In accordance with one aspect of the present invention, the machine also comprises recognition means operatively connected to the processor and configured to recognize and/or detect the presence of at least one of one or several activation means which are at least temporarily connected to or associated with the machine. In addition, with each of the activation means there are associated additional packets of data and programs relating to additional operating functions associated with the activation means.

Once the processor has received a signal of recognition of a certain activation mean, it can process the packets of data and programs and make the other functions available on the machine.

In accordance with one aspect of the invention, the recognition means are configured to send a signal to the processor at the time of a first recognition of the presence of one of the activation means, and the processor is configured to activate or make available in electronic memory means another packet of data and programs relating to additional operating functions associated with the recognized activation mean.

Doing so achieves at least the advantage that a user, by means of simple operations which substantially provide to associate the activation means with the machine, is able to update the machine by adding to it, or integrating in it, additional operating functions associated with the activation means.

In particular, the machine can be marketed with a first basic configuration, and it can assume an updated configuration following the at least temporary connection or association of at least one of the activation means.

In the updated configuration, the machine preferably comprises both the operating functions already provided in the basic configuration, and also other additional operating functions associated with the other packet of data and programs that has been activated or made available.

In accordance with another aspect of the present invention, the activation means and/or the recognition means are of the physical type. According to this embodiment, the activation means can comprise one or more accessory members physically connectable to the machine, and the recognition means can comprise detection members and/or sensors suitable to detect the presence of a respective accessory member.

In this case, the recognition means can comprise both detection members and/or sensors suitable to recognize an accessory member each time it is connected to the machine, and also updating means suitable to cooperate with the detection means and the processor at least when the accessory member is connected to the machine for the first time, in order to determine the activation of a respective packet of data and programs and therefore the updating of the machine with the operating functions associated with the recognized accessory member.

In accordance with another aspect of the present invention, the activation means and/or the recognition means are of the virtual and/or digital type. According to this embodiment, the activation means can comprise one or more computer codes, each of which identifies one or more of the additional operating functions. In this case, the recognition means can comprise or consist of a user interface by means of which the computer code can be received, for example by means of a code reader, an alphanumeric keyboard, or a wireless transmission.

In accordance with another aspect of the present invention, the electronic memory means are configured to store the additional packets of data and programs.

In accordance with another aspect of the present invention, the additional packets of data and programs are already pre-stored in the electronic memory means.

In accordance with another aspect of the invention, in the electronic memory means there are stored both packets of data and programs configured to be executed during the normal operation of the machine in a basic configuration thereof, and also additional packets of data and programs which are in a dormant status and temporarily deactivated in the basic configuration and are configured to be made available by the processor upon the first recognition of a specific activation mean, in an updated configuration of the machine.

In accordance with another aspect of the present invention, the processor is able to be selectively connected to a communication network, and it is programmed to connect automatically, or selectively, to such communication network in order to download and/or update the additional packets of data and programs when the additional packets of data and programs are not already pre-stored in the electronic memory means, or they are not updated.

In accordance with another aspect of the present invention, the processor is programmed, or programmable, to activate the additional operating functions and command the preparation and delivery of one or more additional beverages and/or other functions relating to the certain beverage, when the recognition means recognize or detect the presence of at least a specific one of the activation means, making the possibility of selecting the one or more additional beverages and/or the other functions associated with the certain beverage accessible to the user, by means of the user interface.

In accordance with another aspect of the present invention, the machine also comprises one or more housing seatings, each configured to house a specific one of the one or more accessory members, and in correspondence with which the detection means are disposed.

In accordance with another aspect of the present invention, the machine comprises coupling members configured to couple to the accessory members, wherein the coupling members can themselves define the detection means or be connected to them, and in correspondence with which there are disposed respective detection members.

In accordance with another aspect of the present invention, a method for preparing beverages, including coffee-based beverages, comprises a setting step in which a machine is made available comprising a brewing unit configured to prepare at least one certain beverage at a time selected from the beverages disclosed above, a main hydraulic circuit to feed water to the brewing unit, a delivery unit fluidically connected to the brewing unit and configured to deliver the certain beverage, a processor operatively connected to the brewing unit, to the main hydraulic circuit and to the delivery unit in order to control and command their drive, electronic memory means connected to the processor and configured to store packets of data and programs relating to operating functions associated with the beverages as above, and a user interface communicating with the processor to select the certain beverage.

The method also comprises a recognition step in which recognition means, operatively connected to the processor, recognize and/or detect the possible presence of one or several activation means which are at least temporarily connected to or associated with the machine, and an updating step in which the processor activates the electronic memory means in order to store in them, or remove from them, additional packets of data and programs relating to additional operating functions associated with the one or several activation means, and selectively activates the additional operating functions.

In accordance with another aspect of the present invention, the method also comprises an enabling step in which the processor enables the additional operating functions in the user interface, and therefore allows the user to perform the selection of one or more additional beverages and/or other functions associated with the certain beverage.

In accordance with another aspect of the present invention, the method also comprises an actuation step in which the processor, upon user input by means of the user interface, commands the preparation and delivery of the one or more additional beverages and/or the other functions associated with the certain beverage.

In accordance with another aspect of the present invention, the method also comprises a connection step in which the processor automatically or selectively connects to a communication network in order to download and/or update the additional packets of data and programs, when the additional packets of data and programs are not available or are not updated.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic and simplified representation of a machine for preparing beverages, according to the present invention;

FIG. 2 is a front view of a machine for preparing beverages, according to the present invention;

FIG. 3 is a schematic and simplified representation of a machine for preparing beverages, according to another embodiment of the present invention;

FIG. 4 is a front view of the machine for preparing beverages of FIG. 3.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

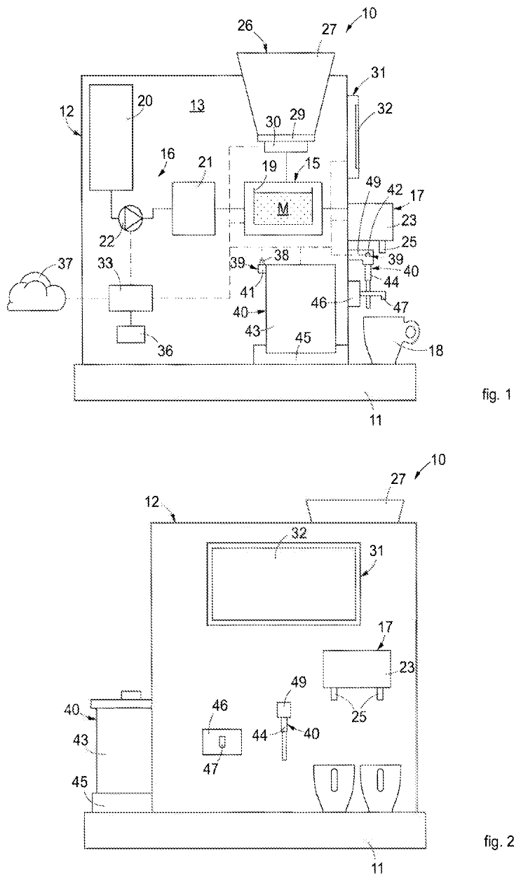

With reference to FIG. 1, a machine 10 according to the present invention can be used to prepare one or more beverages, for example coffee-based beverages, but also tea-based or based on other types of aromatic blends.

In the following description, by way of example, we will refer to a machine 10 of the automatic type, in which the loading of the coffee powder and possibly also its removal, after it has been used, occur automatically.

In accordance with other embodiments of the present invention, the machine 10 can be of the semi-automatic type, as specified above.

The machine 10 comprises a rest plane 11 on which there is mounted a frame 12 shaped so as to have, internally, a compartment 13 in which there are housed a brewing unit 15, of a known type, capable of preparing a certain beverage, a hydraulic circuit 16 to feed water to the brewing unit 15, as well as a delivery unit 17 fluidically connected to the brewing unit 15 and which allows to deliver the certain beverage into a container 18, for example a cup, a mug, or suchlike.

The brewing unit 15 comprises at least one brewing chamber 19 which is configured to contain a certain quantity of aromatic blend M to be subjected to brewing, so as to obtain the certain beverage.

For example, the aromatic blend M can be a powder blend, for example of coffee, or a blend of tea leaves, even partly crushed, or of other vegetable substances.

The hydraulic circuit 16 comprises a tank 20 that can be filled with drinking water, a boiler 21 having the function of heating the water directed toward the brewing unit 15 and a feed pump 22 which feeds the water into the boiler 21.

The delivery unit 15 comprises a delivery member 23 attached to the frame 12 and provided, in the example given here, with two nozzles 25 (FIG. 2), to simultaneously deliver the certain beverage toward two different containers 18.

In accordance with other embodiments of the present invention, only one nozzle 25 can be provided, or more than two nozzles 25 can also be provided.

In accordance with one embodiment of the present invention, the machine 10 also comprises a grinding device 26 (FIG. 1) configured to grind the coffee beans, so as to obtain a certain aromatic blend M.

The grinding device 26 comprises a hopper 27 which is at least partly inserted in the compartment 13 and into which the coffee beans to be ground can be introduced, a dosing member 29 to dose the right quantity of beans, and a grinding member 30 to grind the coffee beans according to a desired granulometry.

The machine 10 also comprises a user interface 31 provided with a display device 32, for example a touchscreen, by means of which a user can select the certain beverage and set one or more of its characteristics, as well as any variables or operating modes of the machine 10.

In addition, the machine 10 comprises a processor 33 of the electronic type, which is connected at least to the brewing unit 15, to the hydraulic circuit 16, to the delivery unit 17, to the grinding device 26 and to the user interface 31, which are collectively defined as “operating components”, in order to command and coordinate their operation.

The processor 33 is operatively connected to electronic memory means, in particular to a memory unit 36, in which both data packets and also programs are stored or can be stored, which are capable of making the operating components described above perform at least all the functions necessary to deliver the certain beverage chosen, on each occasion, by a user.

In accordance with some embodiments of the present invention, the memory unit 36 can be either physically present in the machine 10 (FIG. 1), or contained on an external magnetic medium but able to be selectively associated with the machine 10 in order to become a part of it, such as for example a so-called USB key, or other computer device of a known type, or which will be developed in the future, or it can be of a virtual type, that is, located on a so-called “cloud” platform.

Furthermore, the processor 33 is of the type which is able be connected, preferably in wireless mode, to a communication network, such as the Internet, indicated with the reference number 37 in FIG. 1.

In accordance with one aspect of the present invention, the machine 10, which leaves production and is commercially introduced on the market with a “basic” configuration, or version, has the characteristic of being able to be updated, for example by means of a simple intervention of the same user, when he/she wishes to integrate one or more additional functions into the “basic” machine 10.

For example, the user may also wish to obtain, through the machine 10, beverages that are different from those for which it is initially prepared, for example, but not limited to, an Americano coffee, a latte, a macchiato coffee, etc. In this case, the machine 10 can assume an “updated” configuration, or version, that includes the functions of the “basic” configuration as well as other additional functions.

This can happen because, in a new and original way, the machine 10 is provided with special recognition, or detection, means 39 configured to detect and recognize the presence of certain activation means 40, each of which allows to activate, or enable, a respective additional operating function of the machine 10.

In accordance with some embodiments, in the memory unit 36 there can be stored both packets of data and programs that have an active status and are configured to be executed during the normal operation of the machine 10 in its basic configuration, as well as additional packets of data and programs that have a dormant status, which are temporarily disabled when the machine 10 is in the basic configuration and are configured to be made available by the processor 33 at the time of a first recognition of a specific activation mean 40, as will be explained below, and are made operative in an updated configuration of the machine 10.

According to embodiments described with reference to FIGS. 1 and 2, the activation means 40 can be of the physical type, such as for example physical accessory members 43, 44 able to be connected to or associated with the machine 10.

In accordance with these embodiments, the recognition means 39 can comprise at least a first detection member 41 and a second detection member 42 (FIGS. 1 and 2) of the physical type.

According to these embodiments, the recognition means 39 can comprise both the detection members 41, 42, which are suitable to recognize a specific accessory member 43, 44 each time it is connected to the machine 10, and also updating means 38 suitable to cooperate with the detection means 39 and the processor 33 at least when the accessory member 43, 44 is connected to the machine 10 for the first time, in order to determine the activation of a respective packet of data and programs and therefore the updating of the machine 10 with the operating functions associated with the recognized accessory member 43, 44.

The updating means 38 can be integrated in the detection members 41, 42 or even be elements separate from them, but suitable to supply to the processor 33 information regarding the fact that one of the accessory members 43, 44 has been connected to machine 10 for the first time, so as to determine the activation or the availability of the respective packet of data or programs.

The updating means 38 can also be integrated in the processor 33 itself, and be configured to identify when an activation mean 40 is connected to or associated with the machine 10 for the first time, or possibly even after a certain time interval, so as to determine the activation or updating, respectively, of the specific packet of data or programs.

The detection members 41 and 42 are substantially of a known type, such as sensors or micro-switches for example, and each one is configured to detect, or recognize, a specific accessory member, which can be, by way of example, a specific jug 43, suitable to contain milk and having a certain shape and size, or a steam delivery lance 44.

For example, if the accessory member is the specific jug 43, on the rest plane 11 there can be a first housing seating 45 in which the user can position the jug 43. The first detection member 41, which can be driven by the insertion of the jug 43, can be disposed in correspondence with the first housing seating 45.

For example, the first housing seating 45 can be suitably shaped so that only the specific jug 43, and not any other jug, can couple to it precisely. Furthermore, the first housing seating 45 can be provided with suitable guides and/or clamping mechanisms, not shown in the drawings, to keep the jug 43 stably housed in the housing position.

In addition, in order to be able to deliver the milk correctly, the machine 10 can comprise another delivery member 46 (FIGS. 1 and 2), which is provided with a respective delivery nozzle 47.

If the accessory member is the lance 44, there can be a second housing seating 49 in proximity to the delivery member 23, in which the user can insert the lance 44 and in correspondence with which the second detection member 42 is present. For example, the coupling between the lance 44 and the second housing seating 49 can occur by means of a suitable snap-in mechanism, or by screwing.

Please note that the jug 43 and/or the lance 44, when they are disposed in the respective housing seatings 45 and 49 are, in fact, operatively connected to the machine 10 and in particular to corresponding auxiliary hydraulic circuits of the latter, which can be of a known type and are not shown in the drawings. These auxiliary hydraulic circuits have the function of allowing additional operating functions associated with the jug 43 and/or the lance 44 to be carried out, in order to prepare one or more additional beverages and/or to perform other functions relating to the certain beverage as above.

According to possible variants, it can also be provided that in one or more housing seatings 45, 49 there are also disposed two or more detection members 41, 42, of a different type, or the same, possibly disposed in different positions from each other, each suitable to detect the presence of the activation means 40 associated with a specific accessory member 43, 44.

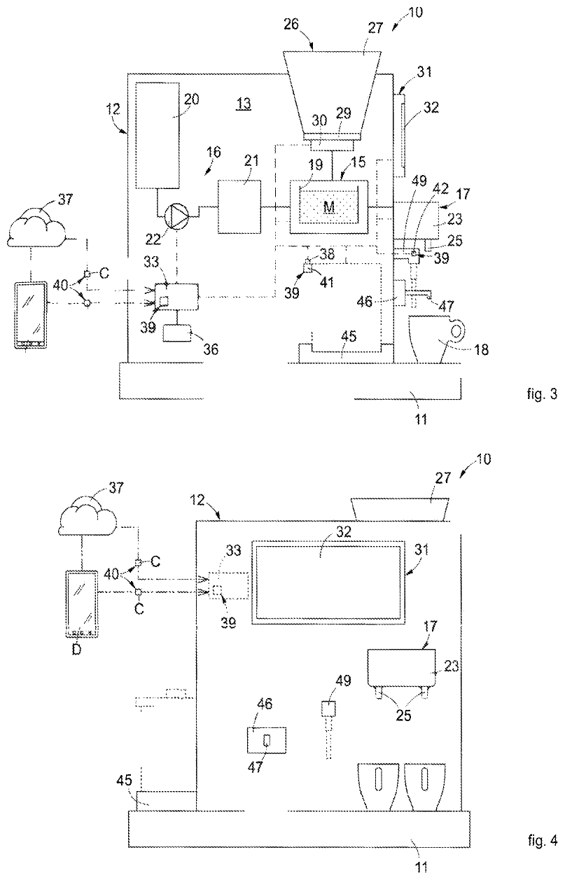

According to embodiments described with reference to FIGS. 3 and 4, which can also be combined with the embodiments of FIGS. 1 and 2, the activation means 40 can be of the virtual and/or digital type, such as specific computer codes C for example, identifying corresponding additional operating functions.

The computer codes C can comprise, for example, strings of alphanumeric characters, bar codes, QR codes, which can be received directly through an application or via e-mail following the purchase of a particular packet of additional features, or possibly supplied inside a package or packaging of one or more accessory members 43, 44.

According to these embodiments, the recognition means 39 can comprise, or consist of, an interface, for example the user interface 31 of the machine 10, or a dedicated application installed on a computerized device D, by means of which the computer code C can be received and transmitted to the processor 33, for example by means of a code reader, for example a bar code or a QR code, an alphanumeric keyboard, and/or wireless transmission.

In accordance with another aspect of the present invention, the memory unit 36 is configured to also store additional packets of data and programs relating to the additional operating functions disclosed above, which are associated with the accessory members and therefore with the jug 43 and/or the lance 44.

In order to do this, the processor 33 is programmed, or programmable, to activate the additional operating functions as above and command the preparation and delivery of at least one of the additional beverages and/or the other functions associated with the certain beverage, when the detection elements 41 and 42 detect the presence of the jug 43 and/or the lance 44. In this case, the operating functions can be suitable for the preparation of milk foam and/or steam.

Furthermore, the processor 33 is able to make the possibility of selecting one or more additional beverages and/or other functions associated with the certain beverage accessible to the user, by means of the user interface 31.

In accordance with another aspect of the present invention, the additional packets of data and programs relating to the additional operating functions as above, in particular those associated with the jug 43, or with the lance 44, can be already pre-stored in the memory unit 36. In this case, these additional operating functions are to be considered “dormant”, that is, temporarily disabled and not available to the user, until the jug 43 or the lance 44 is associated with the machine 10.

Alternatively, if the additional packets of data and programs are not already pre-stored, or are not updated, the processor 33 is programmed to automatically or selectively connect to the communication network 37, for example by means of a command generated by the user interface 31, in order to download and/or update such additional packets of data and programs, so as to make them available for the subsequent storage in the memory unit 36.

In accordance with other possible embodiments of the present invention, shown in FIGS. 3 and 4, if the activation means 40 also or alternatively consist of computer codes C, the recognition means 39 can be integrated even directly into the processor 33 and be configured to recognize each computer code C associated with a respective additional operating function of the machine 10.

The computer codes C can be downloadable by a user either directly from the machine 10, when it is connected to the communication network 37, or through a computerized device D, for example a mobile phone, operatively connected, preferably in wireless mode, to the machine 10.

In particular, each computer code C can contain digital information which allows the processor 33 to use the additional packets of data and programs already pre-stored in the memory unit 36, so as to enable the respective additional operating function, or to automatically or selectively connect to the communication network 37, by means of a command generated by the user interface 31 for example, in order to download and/or update the additional packets of data and programs relating to the respective additional operating function.

By way of example, a computer code C can allow to enable in the machine 10 a beverage not yet present in the list of beverages that can be initially selected by the user on the user interface 31, or to activate new operating functions associated with an accessory member 43, 44.

The operation of the machine 10 described heretofore, which corresponds to the method according to the present invention, comprises the following steps.

In an initial setting step, a machine 10 as described above is made available.

In a subsequent activation step, at least one of the activation means 40 is associated with, or integrated into, the machine 10. In particular, if the activation means 40 are physical accessories (FIGS. 1 and 2), at least one of them, that is, the jug 43 and/or the lance 44, is temporarily disposed in the respective housing seating 45, 49.

Alternatively, or in addition, if the activation means 40 are computer codes C (FIGS. 3 and 4), at least one computer code C is downloaded or obtained in this activation step, according to the modes described above.

Then, in a recognition or detection step, the recognition means 39 detect and recognize the possible presence or reception of the activation means 40, whether these are the accessory members 43, 44 or the computer codes C. In particular, in the case of the accessory members 43, 44 (FIGS. 1 and 2), each detection member 41, 42 detects the possible presence of the jug 43 and/or of the lance 44, and sends the data relating to one or the other, or both, to the processor 33.

In the case of the computer codes C (FIGS. 3 and 4), on the other hand, the recognition means 39 allow the processor 33 to receive and process the computer code C detected.

Subsequently, in an updating step, if the additional packets of data and programs relating to the additional operating functions associated with the activation means 40 (FIGS. 1, 2, 3 and 4) are already pre-stored in the memory unit 36, the processor 33 takes and/or executes them, and activates the additional operating functions.

In the event that the additional packets of data and programs are not already pre-stored in the memory unit 36, or they are not updated, in a connection step the processor 33 automatically or selectively connects to the communication network 37, for example by means of a command generated by the user interface 31, in order to download and/or update such additional packets of data and programs, so as to make them available for the subsequent storage in the memory unit 36.

In addition, in an enabling step, the processor 33 enables, in the user interface 31, the additional operating functions and thus allows the user to perform the selection of one or more additional beverages and/or other functions associated with the certain beverage.

Then, in an actuation step, the processor 33, upon user input by means of the user interface 31, commands the preparation and delivery of at least one of the additional beverages and/or the other functions associated with the certain beverage.

It is clear that modifications and/or additions of parts may be made to the machine 10 and to the method as described heretofore, without departing from the field and scope of the present invention, as defined by the claims.

For example, in accordance with other embodiments of the present invention, the accessory members could be more than two, or they could be different from those described above, possibly with other associated operating functions.

It is also clear that, although the present invention has been described with reference to some specific examples, a person of skill in the art shall certainly be able to achieve many other equivalent forms of machines and methods for preparing beverages, having the characteristics as set forth in the claims and hence all coming within the field of protection defined thereby.

In the following claims, the sole purpose of the references in brackets is to facilitate their reading and they must not be considered as restrictive factors with regard to the field of protection defined by the same claims.

1. A machine (10) for preparing beverages, the machine comprising: a brewing unit (15) configured to prepare at least one certain beverage, a hydraulic circuit (16) to feed water to said brewing unit (15), a delivery unit (17) configured to deliver said certain beverage, a processor (33) operatively connected to said brewing unit (15), to said hydraulic circuit (16) and to said delivery unit (17) to control and command a drive of said brewing unit (15), said hydraulic circuit (16) and said delivery unit (17), electronic memory means (36) connected to said processor (33) and configured to store packets of data and programs relating to operating functions associated with said beverages, and a user interface (31) communicating with said processor (33) to select said certain beverage, said machine (10), said machine further comprising: recognition means (39) operatively connected to said processor (33) and configured to recognize a presence of at least one of one or several activation means (40) which are at least temporarily connected to or associated with said machine (10), wherein with each of said activation means (40) there is associated additional packets of data and programs relating to additional operating functions associated with said activation means (40) and wherein said recognition means (39) are configured to send a signal to said processor (33) at least following a first recognition of the presence of one of said activation means (40), and said processor (33) is configured to activate or make available in said electronic memory means (36) an additional packet of data and programs relating to additional operating functions associated with said recognized activation means (40).

2. The machine (10) as in claim 1, wherein said activation means (40) comprise one or more accessory members (43, 44), each suitable to perform its own operating functions, and said recognition means (39) comprise one or more detection members (41, 42), each configured to detect the presence of a specific accessory member (43, 44).

3. The machine (10) as in claim 2, wherein said recognition means (39) comprise both said detection members (41, 42) suitable to recognize said specific accessory member (43, 44) each time it is connected to said machine, and also updating means (38) suitable to cooperate with said detection means (39) and said processor (33) at least when said accessory member (43, 44) is connected to said machine (10) for a first time to determine the activation of a respective packet of data and programs and therefore the updating of said machine (10) with the operating functions associated with said recognized accessory member (43, 44).

4. The machine (10) as in claim 1, wherein said activation means (40) comprise one or more computer codes (C), identifying said additional operating functions, and said recognition means (39) comprise a user interface (31) by means of which said computer code (C) is received and transmitted to said processor (33).

5. The machine (10) as in claim 1, wherein said electronic memory means (36) are configured to store said additional packets of data and programs.

6. The machine (10) as in claim 1, wherein said additional packets of data and programs are already pre-stored in said electronic memory means (36).

7. The machine (10) as in claim 1, wherein in said electronic memory means (36) there are stored both packets of data and programs configured to be executed during the normal operation of said machine (10) in a basic configuration thereof, and also additional packets of data and programs which are in a dormant status and temporarily deactivated in said basic configuration and are configured to be made available by said processor (33) at the first recognition of a specific activation mean (40) in an updated configuration of said machine (10).

8. The machine (10) as in claim 1, in which said processor (33), during use, is connected to a communication network (37), wherein said processor (33) is programmed to connect automatically, or selectively, to said communication network (37) to download or update said additional packets of data and programs when said additional packets of data and programs are not already pre-stored in said electronic memory means (36), or are not updated.

9. The machine (10) as in claim 1, wherein said processor (33) is programmed, or programmable, to activate said additional operating functions and command the preparation and delivery of one or more additional beverages and/or other functions relating to said certain beverage, when said recognition means (39) recognize, or detect the presence of, at least a specific one of said activation means (40), making a possibility of selecting said one or more additional beverages and/or said other functions associated with said certain beverage accessible to the user, by means of said user interface (31).

10. The machine (10) as in claim 2, said machine further comprising one or more housing seatings (45, 49) configured to each house a specific one of said one or more accessory members (43, 44) and in correspondence with which there are disposed respective detection members (41, 42).

11. The machine (10) as in claim 2, wherein said accessory members (43, 44) comprise at least one of either a jug (43) suitable to contain milk, or a steam delivery lance (44), and said additional packets of data or programs are associated with operating functions suitable for the preparation of milk foam and/or steam.

12. A method to prepare beverages, including coffee-based beverages, the method comprising a setting step in which there is made available a machine (10) comprising a brewing unit (15) configured to prepare at least one certain beverage, a main hydraulic circuit (16) to feed water to said brewing unit (15), a delivery unit (17) configured to deliver said beverage, a processor (33) operatively connected to said brewing unit (15), to said main hydraulic circuit (16) and to said delivery unit (17) to control and command a drive of said brewing unit (15), said main hydraulic circuit (16) and said delivery unit (17), electronic memory means (36) connected to said processor (33) and configured to store packets of data and programs relating to operating functions associated with said beverages, and a user interface (31) communicating with said processor (33) to select said certain beverage, said method comprising a first recognition step in which recognition means (39), operatively connected to said processor (33), recognize a presence of at least one of one or several activation means (40) at least temporarily connected to or associated with said machine (10) and send a signal to said processor (33), and an updating step in which said processor (33) activates said electronic memory means (36) in order to store or make available in them at least one of additional packets of data and programs relating to additional operating functions associated with said recognized activation means (40), and selectively activates said additional operating functions.

13. The method as in claim 12, comprising an enabling step in which said processor (33) enables in said user interface (31) said additional operating functions associated with said recognized activation mean (40) and therefore allows the user to perform the selection of one or more additional beverages and/or other functions associated with said certain beverage.

14. The method as in claim 12, comprising an actuation step in which said processor (33), upon user input by means of said user interface (31), commands the preparation and delivery of one or more additional beverages or other functions associated with said certain beverage.

15. The method as in claim 12, comprising a connection step, in which said processor (33) automatically or selectively connects to a communication network (37) to download and/or update said additional packets of data and programs associated with said recognized activation means (40), when said additional packets of data and programs are not available or are not updated.
